(19) United States
(12) Patent Application Publication
(10) Pub. No.: US 2026/0133148 A1
(43) Pub. Date: May 14, 2026

(54) DUAL CHARGED PARTICLE AND ENERGY-DISPERSIVE SPECTROSCOPY IMAGING USING A DIAMOND MEMBRANE

(71) Applicant: FEI COMPANY, Hillsboro, OR (US)

(72) Inventors: Vojtech Mahel, Borsice u Blatnice (CZ); Branislav Straka, Brno (CZ); Libor Novák, Brno (CZ); Petr Hlavenka, Brno (CZ)

(21) Appl. No.: 18/943,577

(22) Filed: Nov. 11, 2024

(51) Int. Cl. G01N 23/2252

(52) U.S. Cl. CPC G01N 23/2252; G01N 2223/507

(57) ABSTRACT

A device, apparatus, and method for simultaneous imaging in charged particle microscopy. The method also includes directing, by a charged particle beam source, a charged particle beam towards a target, where interactions of the charged particle beam with the target generate charged particle emissions and electromagnetic emissions. The method also includes receiving, by a membrane detector, the charged particle emissions and the electromagnetic emissions, where the membrane detector at least partially absorbs a portion of the charged particle emissions and is at least partially transparent to the electromagnetic emissions. The method also includes outputting, by the membrane detector, charged particle signal data based at least in part on the portion of the charged particle emissions received by the membrane detector. The method also includes outputting, by an electromagnetic emission detector, electromagnetic signal data based at least in part on the electromagnetic emissions that pass through the membrane detector.

### FIELD

The present disclosure is directed to charged particle microscope components, systems, and methods. More particularly, the present disclosure describes a dual detector charged particle microscope.

### BACKGROUND

In charged particle microscopy, scanning electron microscopes (SEMs) use electrons rather than light rays to generate images of the specimen being studied. And to understand how SEMs work, it is important to grasp the concept of backscattered electrons (BSEs). BSEs are high-energy electrons used to obtain high-resolution images that show the distribution of various elements that make up a sample. The detection of BSEs is often carried out by detectors that use a semiconductor material, typically silicon, placed directly above the sample. Electrons that hit the detectors excite the silicon electrons, creating an electron-hole pair. Semiconductor detectors are sensitive to electrons with high energy, which is why they're used are to detect backscattered electrons. The free electrons and pairs generated from backscattered electrons can be separated before their recombination, generating a current. This current can be measured by an electronic circuit, which is eventually converted into a high-resolution image containing information about the elemental makeup of the sample. Instead, they will be reflected or “backscattered” out of the sample. In energy dispersive spectroscopy (EDS) applications, detecting X-rays may also be useful. The aim of any EDS detector is to collect the most X-rays possible. However, detecting both backscattered electrons and X-rays has proven difficult as EDS detectors are susceptible to damage from electrons and backscattered electron detectors block X-rays thus leaving small solid angle solutions which are not optimal and take a substantial amount of time to acquire data.

### BRIEF SUMMARY

In some embodiments, a method for imaging in charged particle microscopy. The method also includes directing, by a charged particle beam source, a charged particle beam towards a target, where interactions of the charged particle beam with the target generate charged particle emissions and electromagnetic emissions. The method also includes receiving, by a membrane detector, the charged particle emissions and the electromagnetic emissions, where the membrane detector at least partially absorbs a portion of the charged particle emissions and is at least partially transparent to the electromagnetic emissions. The method also includes outputting, by the membrane detector, charged particle signal data based at least in part on the portion of the charged particle emissions received by the membrane detector. The method also includes outputting, by an electromagnetic emission detector, electromagnetic signal data based at least in part on the electromagnetic emissions that pass through the membrane detector. The method also includes generating target data based at least in part on i) the charged particle signal data, ii) the electromagnetic signal data, or both i) and ii).

In some embodiments, the membrane detector is a diamond membrane detector and outputting the charged particle signal data may include absorbing, by the diamond membrane detector, electrons from the charged particle emissions, and generating image data based at least in part on the electrons such that the target data may include the image data.

In some embodiments, the electromagnetic emission detector may be an energy dispersive spectroscopy (EDS) detector and the electromagnetic emissions may be X-ray emissions. In some examples, outputting the electromagnetic signal data may include receiving, by the EDS detector, the X-ray emissions that pass through the membrane detector, and generating target characterization data based at least in part on the X-ray emissions such that the target data includes the target characterization data.

In some embodiments, the method may include detecting, by the membrane detector, electrons having an energy in an energy range between 1 kiloelectron volts (keV) to 100 keV.

In some embodiments, directing the charged particle beam towards the target may include directing the charged particle beam through a passage of a pole member, directing the charged particle beam through a first aperture in the electromagnetic emission detector, and directing the charged particle beam through a second aperture in the membrane detector. In some examples, the passage, the first aperture, and the second aperture may be coaxially aligned along an axis which passes through the passage, the first aperture, and the second aperture.

In some embodiments, generating the target data occurs without moving the pole member, the electromagnetic emission detector, or the membrane detector with respect to one another; and wherein outputting the charged particle signal data and the electromagnetic signal data occurs substantially contemporaneously.

In some embodiments, the method may include generating a topology mapping of the target using the charged particle emissions; and generating an energy dispersive spectroscopy (EDS) spectrum correction by at least partly applying the topology mapping to target data.

In some embodiments, an apparatus for imaging in charged particle microscopy may include a charged particle source configured to generate a charged particle beam that is configured to interact with a target to generate charged particle emissions and electromagnetic emissions, a membrane detector configured to receive the charged particle emissions and the electromagnetic emissions such that the membrane detector at least partially absorbs a portion the charged particle emissions and is at least partially transparent to the electromagnetic emissions. In some examples, the membrane detector may be configured to output charged particle signal data based at least in part on the membrane detector interacting with the charged particle emissions. In addition, or alternatively, the apparatus may include an electromagnetic emission detector configured to output electromagnetic signal data based at least in part on the electromagnetic emissions that pass through the membrane detector and a controller configured to generate target data based at least in part on i) the charged particle signal data, ii) the electromagnetic signal data, or both i) and ii).

In some embodiments, the controller may be configured to generate an image of the target based at least in part on i) the charged particle signal data, ii) the electromagnetic signal data, or both i) and ii).

In some embodiments, the electromagnetic emission detector may be a silicon drift detector.

In some embodiments, the membrane detector may be configured to be biased with an electric potential relative to the target to change an electron detection threshold.

In some embodiments, the membrane detector may be configured with a segmented electrode for angular electron detection.

In some embodiments, the membrane detector may have a first configuration and, in some examples, the apparatus may include a second membrane detector having a second configuration. In some examples, the first configuration is different than the second configuration.

In some embodiments, the first configuration may include i) a first thickness of the membrane detector, ii) a first bias of the membrane detector, iii) a first position of the membrane detector, or combinations thereof, and wherein the second configuration includes i) a second thickness of the second membrane detector, ii) a second bias of the second membrane detector, iii) a second position of the second membrane detector, or combinations thereof.

In some embodiments, a device for imaging in charged particle microscopy may include a membrane detector configured for placement with respect to a charged particle beam that generates charged particle emissions and electromagnetic emissions when interacting with a target. In some examples, the membrane detector may be configured to at least partially absorb the charged particle emissions and be at least partially transparent to the electromagnetic emissions such that the membrane detector may be further configured to output charged particle signal data based at least in part on the membrane detector interacting with the charged particle emissions, and an electromagnetic emission detector configured to output electromagnetic signal data based at least in part on the electromagnetic emissions that pass through the membrane detector

In some embodiments, the membrane detector may include a segmented area and a thin diamond membrane detector coupled to the segmented area, wherein the segmented area is configured to apply a bias voltage across the thin diamond membrane detector.

In some embodiments, the membrane detector may have a thickness in a range between 100 nanometers (nm) and 100 micrometers (μm).

In some embodiments, the membrane detector includes a first aperture and the electromagnetic emission detector includes a second aperture such that the first aperture and the second aperture are substantially aligned and are configured to receive the charged particle beam therethrough.

In some embodiments, the membrane detector may be configured to be coupled to a surface of the electromagnetic emission detector

In some embodiments, the membrane detector may include an aperture such that during operation of the charged particle beam the membrane detector may be positioned such that the charged particle beam passes through the aperture and the electromagnetic emission detector may be positioned obliquely with respect to the charged particle beam such that the charged particle beam avoids passing through the electromagnetic emission detector

In some embodiments, various technical features, aspects, and advantages of the present disclosure are readily appreciated from the following detailed description. The present disclosure should not be considered limiting, and one or more embodiments discussed herein may be combined in various non-limiting ways. Some or all embodiments herein may be modified without departing from the scope of the present disclosure. The detailed description and drawings may be illustrative of the present disclosure such that advantages of the disclosure will be demonstrated.

### BRIEF DESCRIPTION OF THE DRAWINGS

The foregoing aspects and many of the advantages of the present disclosure will become more readily appreciated as these advantages become better understood by reference to the following detailed description, when taken in conjunction with the accompanying drawings.

FIG. 1 is a simplified schematic diagram of an example charged particle microscope, in accordance with some embodiments.

FIG. 2 is a simplified schematic diagram of an example operation for a charged particle microscope including various detectors, in accordance with some embodiments.

FIG. 3 is a simplified schematic diagram of an example pair of small angle and sequential energy dispersive spectroscopy (EDS) imaging devices.

FIG. 4 is a simplified schematic diagram of an example simultaneous BSE and EDS on-axis detection device, in accordance with some embodiments.

FIG. 5 is a simplified schematic diagram of an example simultaneous BSE and EDS off-axis detection device, in accordance with some embodiments.

FIG. 6 is a simplified schematic diagram of an example portion of a simultaneous BSE and EDS charged particle microscope producing target data, in accordance with some embodiments.

FIG. 7 is a simplified schematic diagram of an example process for attaching a membrane detector to an electromagnetic emissions detector, in accordance with some embodiments.

FIG. 8 is a simplified schematic diagram of an example dual detector configuration, in accordance with some embodiments.

FIG. 9 is a simplified example graph of X-ray transmissivity for a diamond membrane, in accordance with some embodiments.

FIG. 10 is a simplified example graph of detection efficiency of various diamond membranes, in accordance with some embodiments.

FIG. 11 is a simplified side view of a membrane detector carousel, in accordance with some embodiments.

FIG. 12 is a simplified top view of a membrane detector carousel, in accordance with some embodiments.

FIG. 13 is a simplified block flow diagram, in accordance with some embodiments.

FIG. 14 is a simplified controller diagram for a charged particle microscope, in accordance with some embodiments.

In the drawings, like reference numerals refer to like parts throughout the various views and embodiments unless otherwise specified. Not all instances of an element are necessarily labeled to improve clarity in the drawings where appropriate. The drawings are not necessarily to scale, emphasis instead being placed upon illustrating the principles being described.

### DETAILED DESCRIPTION

While illustrative embodiments will be described herein, it will be appreciated that various changes can be made therein without departing from the spirit and scope of the disclosure. In the forthcoming paragraphs, embodiments of charged particle beam systems, components, and methods to detect photons and charged particles simultaneously in systems including such subsystems. Embodiments of the present disclosure focus on scanning electron microscopes (SEM) and related instruments in the interest of simplicity of description. To that end, embodiments are not limited to such systems, but rather are contemplated for charged particle beam systems configured for multiple detector charged particle spectroscopy. While SEMs are described herein as an example use case, it should not be considered limiting, it should be readily recognized that devices, components, methods, and techniques described may be applied to any suitable charged particle microscopy instrument.

Modern scanning electron microscopy imaging provides multimodal information on structure, morphology and composition of complex nanomaterials. Materials scientists need access to more nanoscale information to design, optimize and understand materials properties. Energy-dispersive X-ray spectroscopy (EDS, also abbreviated EDX or XEDS) is an analytical technique that enables the chemical characterization/elemental analysis of materials. A target excited by an energy source (e.g., an electron beam of an electron microscope) dissipates some of the absorbed energy by ejecting a core-shell electron. A higher energy outer-shell electron then proceeds to fill its place, releasing the difference in energy as an X-ray that has a characteristic spectrum based on its atom of origin. This allows for the compositional analysis of a given target volume that has been excited by the energy source. The position of the peaks in the spectrum identifies the element, whereas the intensity of the signal corresponds to the concentration of the element.

As previously stated, an electron beam provides sufficient energy to eject core-shell electrons and cause X-ray emission. Compositional information, down to the atomic level, can be obtained with the addition of an EDS detector to an electron microscope. As the electron probe is scanned across the target, characteristic X-rays are emitted and measured; each recorded EDS spectrum is mapped to a specific position on the target. The quality of the results depends on the signal strength and the cleanliness of the spectrum. Signal strength relies heavily on a good signal-to-noise ratio, particularly for trace element detection and dose minimization (which allows for faster recording and artifact-free results). Cleanliness will impact the number of spurious peaks seen; this is a consequence of the materials that make up the electron column.

It is beneficial to EDS analysis to obtain information related to a target such as surface structures, internal structures, and chemical compositions. To gather this information, two or more distinct detectors are often utilized. For example, conventional microscopes achieve dual measurements with two detectors placed far away from the target. By placing the detectors distal from the target, the two detectors will not interfere with each other but their respective capture angles (e.g., a maximum cone of capture for a respective detector surface) will remain small compared to if the detectors were close to the target. The small solid angles are not optimal and lead to extended capture times since the amount of information reaching the respective detectors is limited. In addition, to protect the EDS detector, an electron trap is commonly used to remove electrons from the X-ray path prior to reaching the EDS detector which adds to costs and complexity. Moreover, EDS detectors and electron detectors are susceptible to damage from ions and milling operations which makes performing experiments while milling a target difficult, cumbersome, and inefficient.

According to embodiments of the present disclosure a dual detector microscope includes a diamond membrane detector and an EDS detector located at a position that is close to the target (e.g., in line below a pole member in between the pole member and the target) such that a large solid capture angle of charged particles emitted from the target is achieved for both the diamond membrane detector and the EDS detector. For example, an electron beam may pass through a pole member which directs the electron beam towards a target. The electron beam may pass through apertures located in the EDS detector and the diamond membrane. These apertures may be concentrically aligned. Once the target interacts with the electron beam, backscattered electrons and X-rays will be generated. The diamond membrane detector, located closer to the target (as compared to the EDS detector), captures, or otherwise absorbs, the backscattered electrons before the backscattered electrons can reach the EDS detector. The diamond membrane detector can then relay the information from the target regarding the backscattered electrons to allow a user (or the system) to obtain information related to surface structures, internal volumes, or similar. Beneficially, the diamond membrane is largely transparent to X-rays and, as such, the X-rays will be allowed to pass through the diamond membrane detector to the EDS detector essentially unimpeded. By using the diamond membrane detector as an effective electron block, a large solid capture angle can be achieved by placing both the diamond membrane detector and the EDS detector close to the target. In addition, or alternatively, by biasing the diamond membrane detector with a suitable electric potential, secondary electrons may be attracted and detected.

In addition to the technical advantages mentioned above, the diamond membrane detector lacks a PN junction intrinsically. This is advantageous in milling operations where stray ions and milling material may fill a vacuum chamber where the detectors are located. For example, detectors commonly use PN detectors which may be damaged by the ions and milling operations necessitating replacement parts and components and elevating the cost to the user operating the microscope. Since the diamond membrane detector completely lacks the PN junction, it is technically advantageous to use it in milling operations since it is resistant to ions and sputtered material. Moreover, due to the electron blocking function of the diamond membrane detector, the EDS detector which is located “behind” the diamond membrane detector does not need an electron trap since the diamond membrane detector blocks the electrons from reaching the EDS detector. This reduces costs of components, reduces a spatial footprint within the vacuum chamber which is advantageous for adding in other components, and improves flexibility. For example, the diamond membrane detector may be retrofit and applied to existing detector solutions with relative ease and, in addition, improves throughput of experiments and milling operations because internal parts (e.g., the EDS detector) do not need to be moved and target data (e.g., surface data, target composition, etc.) may be captured simultaneously with milling, examination, and various other operations.

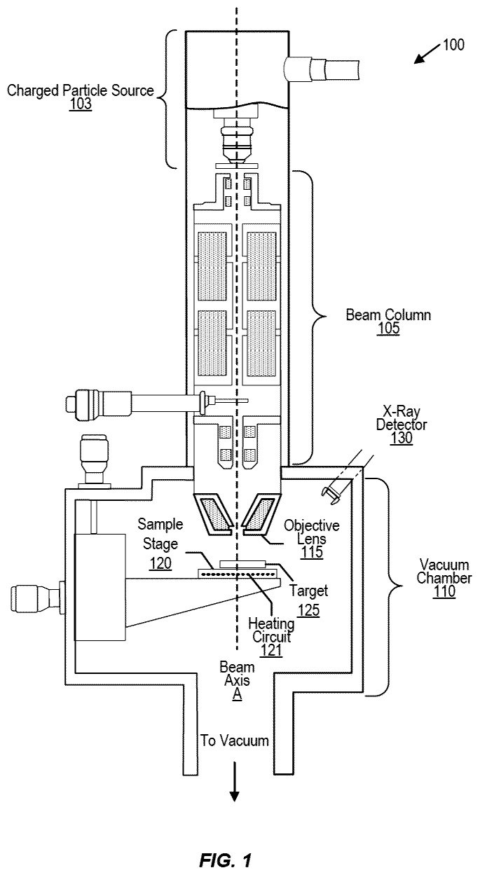

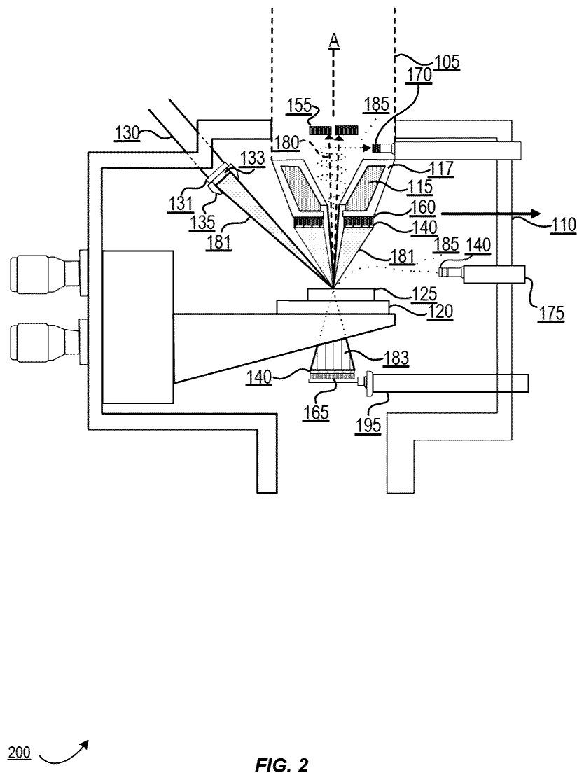

FIG. 1 is a simplified schematic diagram of an example charged particle microscope 100, in accordance with some embodiments. The example charged particle microscope 100 may include multiple sections including a charged particle source 103 (e.g., electron source, ion source, etc.), a beam column 105, and a vacuum chamber 110. The charged particle source 103 includes high-voltage supply components, vacuum system components, and a charged particle emitter configured to generate a beam of charged particles (e.g., electrons) that are accelerated into the beam column 105. The beam column 105, in turn, includes electromagnetic lens elements that are configured to shape and form the beam of charged particles from the charged particle source into a substantially circular beam with a substantially uniform profile transverse to a beam axis A, and conditions the beam to be focused onto a target 125 by an objective lens 115, as described in more detail with respect to FIG. 2.

The beam of charged particles is typically characterized by a beam current and an accelerating voltage applied to generate the beam, among other criteria. The ranges of beam current and accelerating voltage can vary and may be selected based on material properties of the target 125 or the type of analysis being conducted. In some examples, the beams of charged particles are characterized by an energy from about 0.1 keV (e.g., for an accelerating voltage of 0.1 kV) to about sixty keV and a beam current from picoamperes (pA) to microamperes (μm).

The vacuum chamber 110 and/or the beam column 105 can include multiple detectors

for various signals, including but not limited to secondary electrons (e.g., secondary electrons 185 with respect to FIG. 2) generated by interaction of the beam of electrons and the sample, X-ray photons (e.g., energy dispersive X-ray analysis (EDAX)) by way of X-ray detector 130, other photons (e.g., visible and/or infrared (IR) cameras), and/or molecular species (e.g., Time-of-Flight Secondary Ion Mass Spectrometry (TOF-SIMS)), as described in more detail with respect to FIG. 2. The vacuum chamber 110 can also include a target stage 120 that can be operably coupled with a multi-axis translation/rotation control system, such that the target 125 can be repositioned relative to the beam axis A, as an approach to surveying and/or imaging the target 125. The target stage 120 can be thermally coupled with a heating circuit 121. Further the target stage 120 can include windows permitting transmission of electrons or other charged particles through the target 125 and the target stage 120. In this way, one or more charged particle sensors of the present disclosure can be disposed in the vacuum chamber 110 and/or in the beam column 105 and configured to detect backscattered electrons (BSEs) emanating from the sample (e.g., reflected and/or transmitted).

In some embodiments, charged particle microscope 100 may be a single-beam scanning electron microscope (SEM) or transmission electron microscope (TEM) instrument. In some embodiments, charged particle microscope 100 can incorporate a charged particle source (e.g., electron source) adapted, for example, to interrogate the target 125 for microanalysis. In this way, charged particle detectors of the present disclosure can be configured to generate BSE data (e.g., images, line scans, etc.) in coordination with electron sources used for microanalysis of samples. In examples where BSE data is not collected, an ion beam source (e.g., a focused ion beam (FIB)) may be implemented in addition to, or alternatively to the charged particle source. In an illustrative example, a focused ion source (e.g., a plasma focused ion beam (p-FIB) or similar) can be operably coupled with the vacuum chamber 110 and configured to incrementally remove portions of the target 125 in a layer-wise manner. Between increments, BSE imaging (e.g., using the charged particle source) of the target 125 affords a depth profile of elemental information in the target 125, which can be useful for quality assurance in semiconductor applications, as well as in other fields.

FIG. 2 is a simplified schematic diagram of an example operation for a charged particle microscope including various detectors, in accordance with some embodiments. The detectors include a mirror detector (MD) 155, a pole-piece mounted detector (PMD) 160, a STEM mode detector (SMD) 165, as well as other detectors, such as a through-the-lens detector (TLD) 170 and an Everhart-Thornley detector 175. Not shown are other detectors and sources that can be coupled with the vacuum chamber 110 to augment the capabilities of the charged particle microscope 100, as an approach to focusing description on the configurations of charged particle detectors such as the mirror detector 155 and pole-piece mounted detector 160, configured to detect BSEs 180, or forward scattered electrons in the case of SMD 165. To that end, embodiments of the present disclosure include charged particle microscopes including X-ray sources, X-ray detectors, ion-beam sources, mass spectrometers, optical sources (e.g., laser sources), or other sources as would be included in the complement of analytical instruments available for use in SEM microanalysis.

The mirror detector 155 and the TLD 170 are disposed in the beam column 105 or in the objective lens 115. For example, the mirror detector 155 can be disposed above the objective lens 115 and oriented with a sensor surface facing the target stage 120. Advantageously, the position of the MD 155 in the beam column 105 makes the MD 155 well suited for substantially flat target 125 or targets for which the target stage 120 can be reoriented such that the normal angle is substantially aligned with the beam axis A, as angular distribution of BSE 180 emission is highest at the normal angle to the surface of the target 125 in such cases. MD 155 is illustrated without a retaining member or other support structure in FIG. 2 in the interest of focusing description on the position of MD 155 relative to BSEs 180, charged particle microscope 100 components, and the target 125. In some embodiments, MD 155 is mounted on a retractable support 195, as illustrated in SMD 165. In this way, MD 155 can be introduced into position in the beam column 105 and/or objective lens 115 when a BSE 180 imaging/analysis mode is initiated by a user of charged particle microscope 100 and subsequently retracted from the position. In some embodiments, MD 155 is mechanically coupled with components of the beam column 105 and/or objective lens 115 and remains in position when not in use.

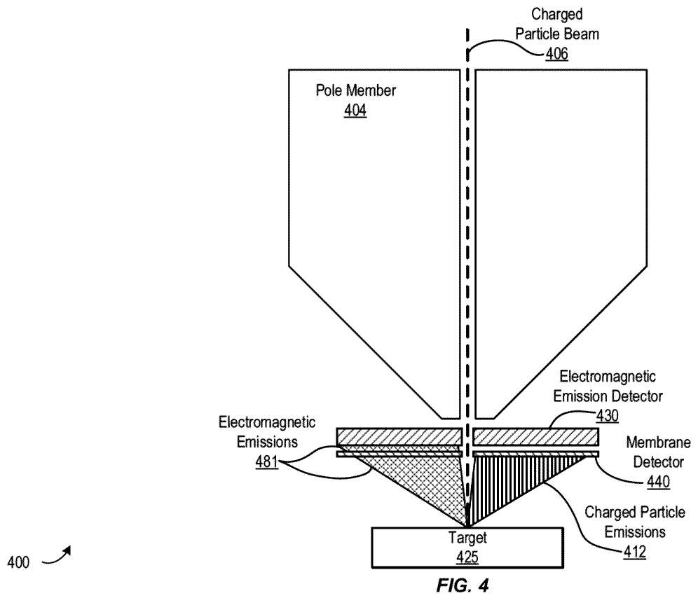

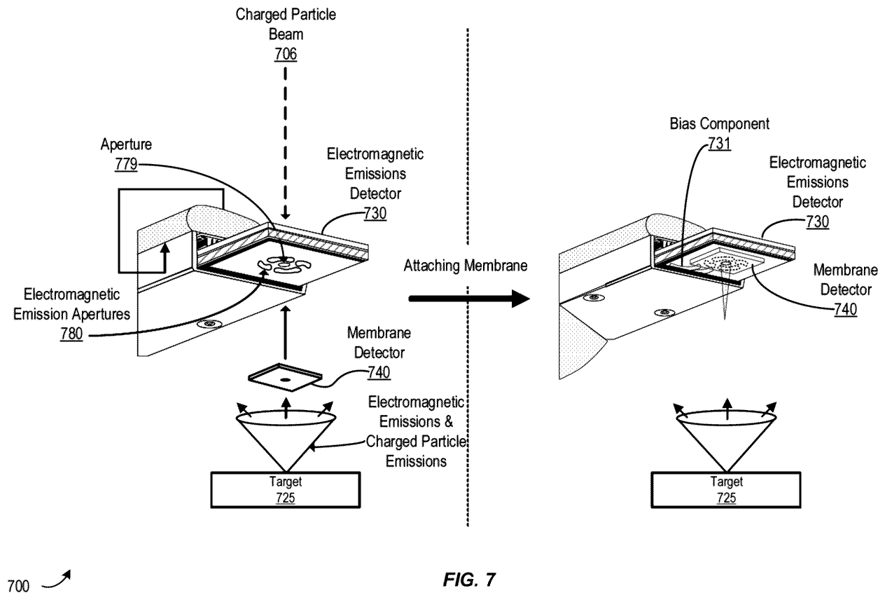

Pole-piece mounted detector (PMD) 160 can be mechanically coupled with a pole member 117 housing the objective lens 115 and oriented with the collector surface facing toward the target stage 120. PMD 160 can be segmented into multiple detectors, such as dipole, tripole, quadrupole, octupole, or other configurations (e.g., combinations of quadrant and concentric configurations). In this way, PMD 160 can compensate for angular distributions centered about a non-zero angle relative to the beam axis A, for example, resulting from surface topography. As which MD 155, PMD 160 can be mounted on a retractable support 195 instead of being mechanically coupled with the pole member 117. Advantageously, mounting PMD 160 on the retractable support 195 permits the PMD 160 to be removed from between the target stage 120 and the pole member 117, allowing other probes, sources, or components to be introduced into the same space (e.g., parabolic mirrors used for luminescence measurement/imaging). For example, PMD 160 (e.g., electromagnetic emissions detector 730 with respect to FIG. 7) may have a membrane detector (e.g., membrane detector 440 with respect to FIG. 4) attached thereto to capture BSE 180 transmitted from the target 125. In some examples, the PMD 160 functions to collect BSE data functioning as a BSE detector or functions to collect EDS data functioning as a EDS detector, or combinations thereof.

A scanning transmission electron microscope (STEM) mode detector 165 can be mechanically coupled with a retractable support 195 configured to introduce the SMD 165 into a position such that the target stage 120 is between the objective lens 115/pole member 117 and the SMD 165. The SMD 165 can be oriented such that the detector surface faces an underside of the target stage 120. In this way, Forward Scattered Electrons (FSEs) 183 emanating from the target 125 can reach the detector surface and generate characteristic signals used for imaging and/or microanalysis. In this context, FSE 183 can include electrons that undergo inelastic or elastic collision with the target 125 and are redirected through the target 125 rather than back toward the beam column 105. In this way, X-rays 181 emanating from the target 125 (e.g., from the region of the interaction volume of the sample in which x-rays are generated) can reach the detector surface and generate characteristic signals used for imaging and/or microanalysis. X-rays 181 can include X-rays generated from inner shell excitations in atoms of the target 125 that are directed through the target 125 rather than back toward the beam column 105. While SMD 165 is presented as an example detector for electrons, it should not be considered limiting, and any suitable detection scheme may be implemented. For example, for the SMD 165, the filter 140 can be disposed between the detector 165 and the target 125, such that charged particles and relatively low energy photons can be absorbed to selectively detect X-rays 181. The SMD 165 may be segmented, similar to the PMD 160, to resolve angular distributions such as, without limitation, bright field, dark field, or high angular dark field.

The filter 140 can be moveable relative to the detector cells. By placing the filter 140 between the absorption surface of the detector cell and the target, the detector can generate X-ray data with negligible or no signal attributable of charged particles and relatively low-energy photons (e.g., infrared, visible, and/or ultraviolet photons). In this way, embodiments of the present disclosure provide improved solid collection angle and improved takeoff angle, relative to the X-ray detector 130, with consequent improvement in integration time, signal-to-noise properties, and reduced exposure of sensitive targets to charged particle dose.

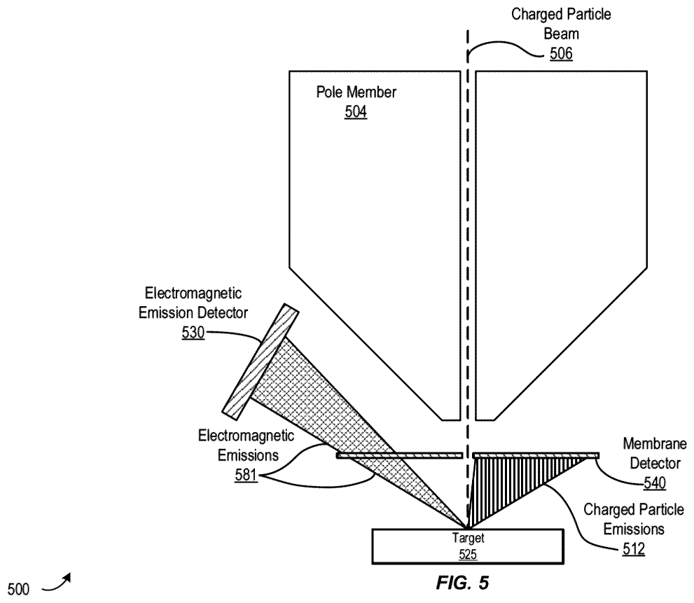

The X-ray detector 130 includes a detector 131 that is shielded from charged particles, photons, and other noise sources by a window 133 and a collimator 135, the collective result of which is a significant reduction of the solid collection angle. Additionally, to protect the window material and/or to reduce the interaction between magnetic components of the X-ray detector 130 and the beam of charged particles, the X-ray detector 130 can be limited to a relatively low takeoff angle, for example, from about thirty to about fifty degrees as measured from a plane defined by the target 125 surface. The takeoff angle can be increased by tilting the target 125, at a cost of reducing the functionality of detectors 155, 160, 165, and 170 during X-ray collection. In some examples, one or more of the detectors 155, 160, 165, or 170 may include, be substituted by, and/or overlap with a membrane detector (e.g., membrane detector 540 with respect to FIG. 5) in order to simultaneously capture various target characteristics (as discussed in more detail later).

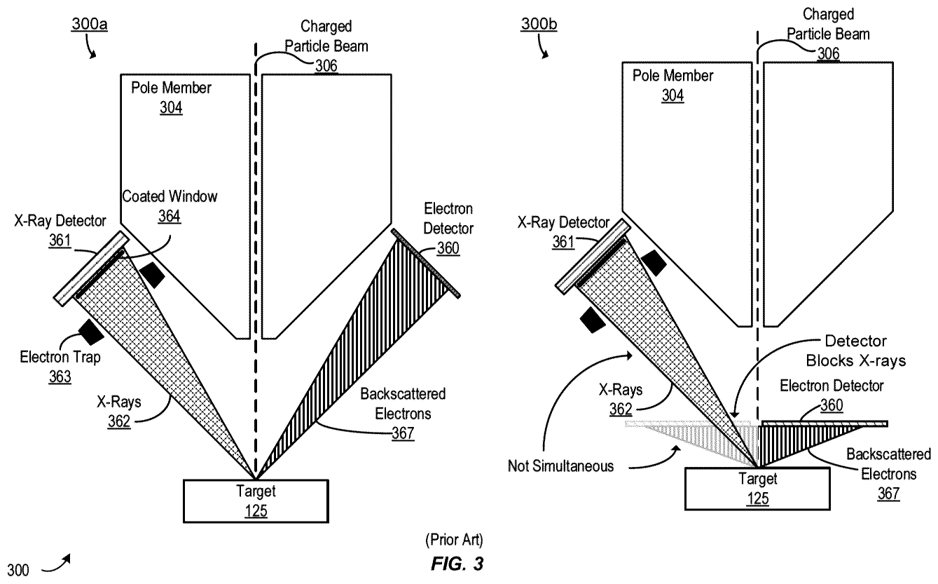

FIG. 3 is a simplified schematic diagram of an example pair 300 of small angle and sequential energy dispersive spectroscopy (EDS) imaging devices. By way of example, a small angle EDS imaging device 300a includes an X-ray detector 361 and an electron detector 360. The X-ray detector 361 is positioned a distance away from a target 125 in order to detect X-rays 362 emitted from the target 125 as a result of a charged particle beam 306 (e.g., primary electron beam) interrogating the target 125 by way of a pole member 304 which directs the charged particle beam 306. The X-ray detector 361 includes a coated window 364 which may function to protect the X-ray detector 361 from incoming particles and atmosphere due to frequent cooling and moisture condensation which may damage the X-ray detector 361. The X-rays 362 may carry characteristic information about the target 125 such as chemical composition. However, the X-ray detector 361 is susceptible to damage from scattered electrons. To remedy this deficiency an electron trap 363 (e.g., a magnet) is used to filter out electrons traveling towards the X-ray detector 361 which may damage or otherwise render the X-ray detector 361 functionally inoperable.

The electron detector 360, similar to the X-ray detector 361, is placed off-axis (compared to an optical/transmission axis of the charged particle beam 306) such that the X-ray detector 361 and the electron detector 360 are not coaxially aligned. This configuration enables substantially simultaneous measurements of backscattered electrons 367 (e.g., using the electron detector 360) and the X-rays 362 (e.g., using the X-ray detector 361). However, due to distances between the target 125 and the electron detector 360 and the X-ray detector 361, respectively, a relatively small capture angle may limit gathering important characteristic information. For example, during some experiments, an amount of backscattered electrons 367 may vastly outweigh an amount of X-rays 362 received by the respective detectors. In order to gain more characteristic information, the capture angle for the X-ray detector 361 should be increased to capture more X-rays 362 which may result in moving the X-ray detector 361 closer to the target 125 or increasing a size of the X-ray detector 361. This may not be optimal due to size constraints within a vacuum chamber (e.g., vacuum chamber 110), cost considerations, and potential damage to the X-ray detector 361 by stray electrons. Similarly, the electron detector 360 may receive a fraction of an optimal amount of electrons due to the small capture angle and off-axis configuration thus limiting an amount of useful characteristic information about the target 125.

Another configuration implements a sequential measurement scheme and increases the amount of useful characteristic information by increasing the capture angle of the electron detector 360, but not the X-ray detector 361. For the sake of clarity, some components depicted in the small angle EDS imaging device 300a have not been labeled in the sequential EDS imaging device 300b. The sequential EDS imaging device 300b includes an X-ray detector 361 and an electron detector 360. Similar to the small angle EDS imaging device 300a, the X-ray detector 361 is configured off-axis. Dissimilar to the small angle EDS imaging device 300a, the electron detector 360 is placed substantially coaxially with the charged particle beam 306 with an aperture therethrough for the charged particle beam 306 to pass through. Due to this configuration, the electron detector 360 will have a larger capture angle for electrons, but may also function to block or otherwise limit X-rays 362 from reaching the X-ray detector 361. To remedy this, an experiment may be broken down into basic temporal parts. The first part would involve capturing backscattered electrons 367 from the target 125 using the electron detector 360 during a first time interval and then physically repositioning the electron detector 360 away from the charged particle beam 306 such that the X-rays 362 from the target 125 are no longer blocked. During a second time interval, the X-ray detector 361 may then capture the X-rays 362 which were previously blocked by the electron detector 360. In this manner, characteristic information about the target 125 may be captured. However, this scheme may take time, effort, and still does not remedy the small capture angle of the X-ray detector 361 thus limiting the amount of useful information obtained.

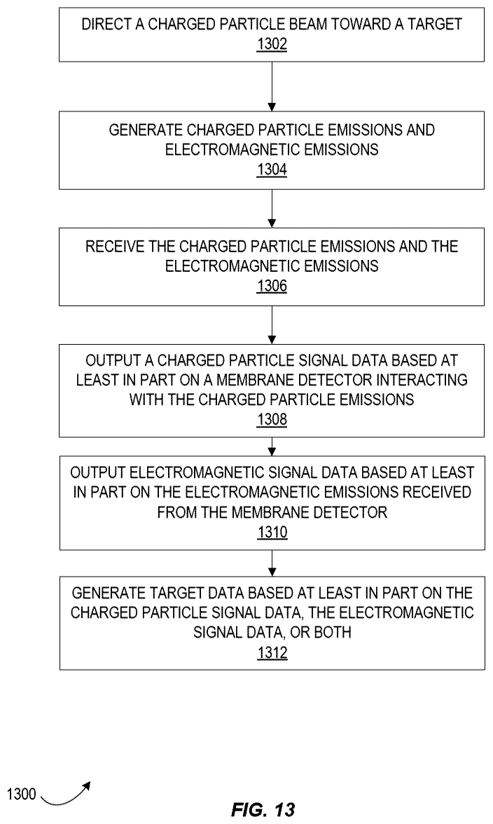

FIG. 4 is a simplified schematic diagram of an example simultaneous BSE and EDS on-axis detection device 400, in accordance with some embodiments. While reference is made to backscattered electrons (BSE) in some examples for clarity of discussion, it should not be considered limiting, and it should readily be recognized that suitable charged particle detectors discussed throughout disclosure may detect electrons that are not backscattered, where suitable. The BSE and EDS on-axis detector device 400 may include some or all components and/or configurations with respect to FIGS. 1, 2, 5-8, 11, 12, and 14 and may function according to some or all operations and/or steps with respect to FIG. 13. In some embodiments, the BSE and EDS on-axis detector device 400 receives a charged particle beam 406 (e.g., electrons, ions, etc.) from a charged particle source (not depicted). The charged particle beam 406 may be directed by a pole member 404 (e.g., electromagnet) towards a target 425 (e.g., a circuit, a protein, a wafer, or similar) by way of a through-hole that extends along the pole member 404 along a transmission axis. Once the charged particle beam 406 exits the pole member 404, the charged particle beam 406 may pass through an aperture of an electromagnetic emission detector 430 (e.g., X-ray detector) and then through a membrane detector 440 to impinge or otherwise interact with the target 425. While not depicted for ease of reference and clarity, a window (e.g., coated window) may be coupled to, or in proximity to, the electromagnetic emission detector 430 or any other suitable detector functioning in conjunction with the membrane detector 440.

When the charged particle beam 406 interrogates the target 425, charged particle emissions 412 (e.g., backscattered electrons) and electromagnetic emissions 481 (e.g., X-rays) may be emitted from the target 425 back towards the membrane detector 440 in a variety of directions depending on a number of factors including, but not limited to, surface topology, interval volume, chemical composition, electrical bias, or similar. While the electromagnetic emissions 481 are depicted as being received on a left side of the transmission axis and the electrons are shown as being received on a right side of the transmission axis, it should be understood that the electromagnetic emissions 481 and charged particle emissions 412 are transmitted from the target 425 in many directions not depicted including outside of depicted capture angle cones for each respective detector. For clarity of discussion and illustration, the electromagnetic emissions are depicted on the left side of the transmission axis and the charged particle emissions 412 are depicted on the right side of the transmission axis and one skilled in the art would recognize that the directions of emissions may be swapped including in and out of the page arbitrarily and spatially overlap.

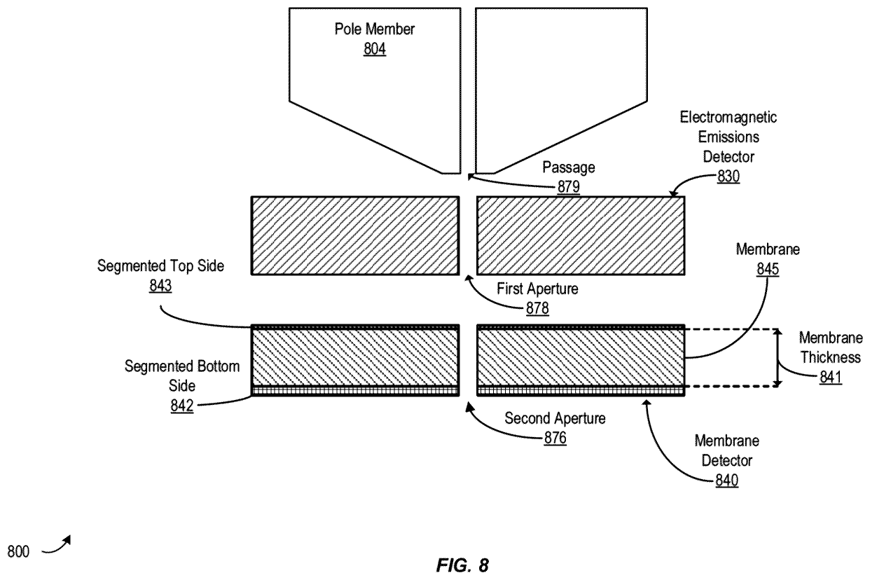

In some examples, the membrane detector 440 may be a wide band-gap semiconductor such as a diamond membrane detector. When the charged particle emissions 412 interact with the membrane detector 440, the membrane detector 440 may at least partially absorb a portion of the charged particle emissions 412 and generate electron-hole pairs that may be separated and driven to respective conducting layers (not depicted) by way of a bias voltage applied to a top surface or bottom surface of the membrane detector 440 (discussed in more detail with respect to FIG. 8). In this manner, the membrane detector 440 may function as an electron detector. The membrane detector 440 may be at least partially transparent to one or more wavelengths of electromagnetic emissions 481. For example, the membrane detector 440 may be at least partially transparent to wavelengths in a range between 0.01 nanometers (nm) and twenty-five nm (e.g., energies between fifty electron volts (eV) and one hundred kiloelectron volts (keV)). While this example illustrates transparency to X-rays, it should not be considered limiting and one skilled in the art would recognize that the membrane detector 440 may be transparent to any suitable electromagnetic emission such as infrared light, visible light, ultraviolet light, or similar. In addition, or alternatively, the membrane detector 440 may be at least partially transparent to a first range of wavelengths and at least partially opaque to a second range of wavelengths.

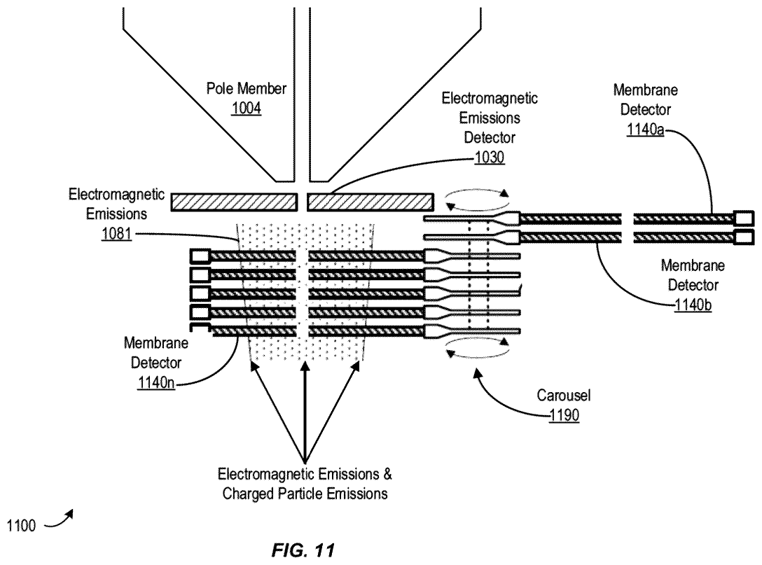

The membrane detector 440 may include a group of membrane detectors arranged in a stack which may be individually, or in a group, added in line (e.g., repositioning, rotating, etc.) with the charged particle beam 406. Each membrane detector 440 in the group of membrane detectors may be made of dissimilar materials or may be made from the same material (e.g., carbon nanotubes, diamond, etc.). Each membrane detector 440 in the group of membrane detectors may be in contact with one another or may be spaced from one another by a suitable distance (as discussed in more detail with respect to FIG. 11). Each membrane detector 440 in the group of membrane detectors may have a different thickness or may have the same thickness (as discussed in more detail with respect to FIG. 8).

In some examples, the electromagnetic emission detector 430 may be an EDS detector such as a silicon drift detector (SDD) which receives electromagnetic emissions 481 from the target 425 which have passed through the membrane detector 440. Due to the membrane detector 440 at least partially absorbing or otherwise limiting charged particles from reaching the electromagnetic emission detector 430, a full electromagnetic capture angle (e.g., compared to a small capture angle with respect to FIG. 3) for electromagnetic emissions 481 is created for the membrane detector 440 thus increasing an electromagnetic signal captured of the target 425. Generally speaking, smaller capture angles lead to longer acquisition times than larger capture angles since it takes more time to gather enough photons to provide accurate target data. With that in mind, due to the full electromagnetic capture angle provided by this membrane detector 440 / electromagnetic emission detector 430 configuration, a time to capture target data is significantly decreased since more data is collected in a shorter interval of time compared to having to wait for a small capture angle configuration to capture enough photons to provide similar results. In a non-limiting example, this configuration affords a user of the EDS and X-ray on-axis detector device 400 the capability (e.g., using a graphical user interface (GUI)) to monitor target 425 composition (e.g., target data from electromagnetic emission detector 430) and target 425 surface topology/topography substantially contemporaneously (e.g., at the same time) with fast data acquisition times, improved signal throughput, and improved on-demand capabilities such as monitoring-while-milling (as discussed below).

Returning now to the discussion of the membrane detector 440. Due to the optimal properties of using a diamond membrane detector such as characteristically low X-ray absorption rates (e.g., allows at least some X-rays to pass therethrough) and an advantageous resistance to ions (e.g., diamond has no PN junction that can be damaged by ions) and sputtered materials, the diamond membrane detector is ideally suited to gather backscattered electrons and allowing X-rays to pass therethrough to electromagnetic emission detector 430 during milling operations, SEM/STEM operations, or similar. By way of a non-limiting example, an ion beam (not depicted) may be located proximal to the target 425 within a vacuum chamber (e.g., vacuum chamber 110 with respect to FIG. 1) in order to modify the target 425 in some suitable manner. A user interacting with the simultaneous BSE and EDS on-axis detection device 400 may monitor the target 425 by way of the membrane detector 440 and the electromagnetic emission detector 430 and may receive information such as a surface topology from the membrane detector 440 and a chemical composition from the electromagnetic emission detector 430. The user (or automated system) may identify a specific unwanted chemical composition on the target 425 (e.g., using electromagnetic emission detector 430) and may direct the ion beam to mill the unwanted chemical composition off of the target 425. The user may determine quickly that the unwanted chemical composition on the target 425 has been milled away by monitoring both the charged particle signal and the electromagnetic signal to determine if the milling process was successful. By comparison with a user using conventional small angle or sequential EDS devices, the user would have to wait a prolonged period of time associated with either acquiring enough signal to make a determination or the user would have to remove the charged particle detector prior to detecting electromagnetic emissions which would cost time and effort. The configuration of the present embodiment remedies these deficiencies by obtaining the charged particle signal and the electromagnetic signal substantially contemporaneously and in a compact coaxial manner.

FIG. 5 is a simplified schematic diagram of an example simultaneous BSE and EDS off-axis detection device, in accordance with some embodiments. The BSE and EDS off-axis detector device 500 may include some or all components and/or configurations with respect to FIGS. 1, 2, 4, 6-8, 11, 12, and 14 and may function according to some or all operations and/or steps with respect to FIG. 13. The BSE and EDS off-axis detector device 500 includes a membrane detector 540 aligned substantially coaxially with a pole member 504 (e.g., pole member 117 with respect to FIG. 1) such that a first aperture of the membrane detector 540 receives a charged particle beam 506 from a passage of the pole member 504. After passing through the first aperture of the membrane detector 540, the charged particle beam 506 interrogates the target 525 (as discussed previously). Subsequently, charged particle emissions 512 and electromagnetic emissions 581 are generated and transmitted outwards. Similar to the BSE and EDS on-axis detector device 400 device, the membrane detector 540 is spatially located at a large capture angle position. While the membrane detector 540 is depicted as being substantially coplanar with the target 525, it should be recognized by one skilled in the art that the membrane detector 540 may be positioned and/or oriented at any suitable angle relative to the target 525 and/or electromagnetic emission detector 530. For example, some existing systems that may be retrofitted with the membrane detector 540 of the present embodiment may have electromagnetic emission detectors 530 at obscure or unique positions such that the membrane detector 540 may not be able to adequately capture enough of the charged particle emissions 512 if installed in a planar fashion. In this non-limiting example, the membrane detector 540 may be installed at an angle relative the electromagnetic emission detector 530 to adequately protect the electromagnetic emission detector 530 from damage by the charged particle emissions 512. The angle may be in a range between zero degrees and forty-five degrees relative to a supporting surface plane of a target stage (e.g., target stage 120 with respect to FIG. 1) which supports the target 525.

As previously mentioned, the BSE and EDS off-axis detector device 500 includes the electromagnetic emission detector 530 which is placed off-axis relative to the transmission axis of the charged particle beam 506. This configuration is particularly well suited for charged particle microscopes with multiple detectors positioned at various angles within the vacuum chamber. The membrane detector 540 may function, as discussed previously, to substantially limit or otherwise block charged particle emissions from reaching the electromagnetic emission detector 530. In some examples, the electromagnetic emission detector 530 may be one of a group of electromagnetic emission detectors and/or other suitable detectors (e.g., secondary electromagnetic emission detectors, temperature sensors, laser milling depth sensors, etc.). Since the membrane detector 540 may be substantially transparent to one or more wavelengths of electromagnetic light, the membrane detector 540 may pass suitable wavelengths of light to the respective electromagnetic emission detectors.

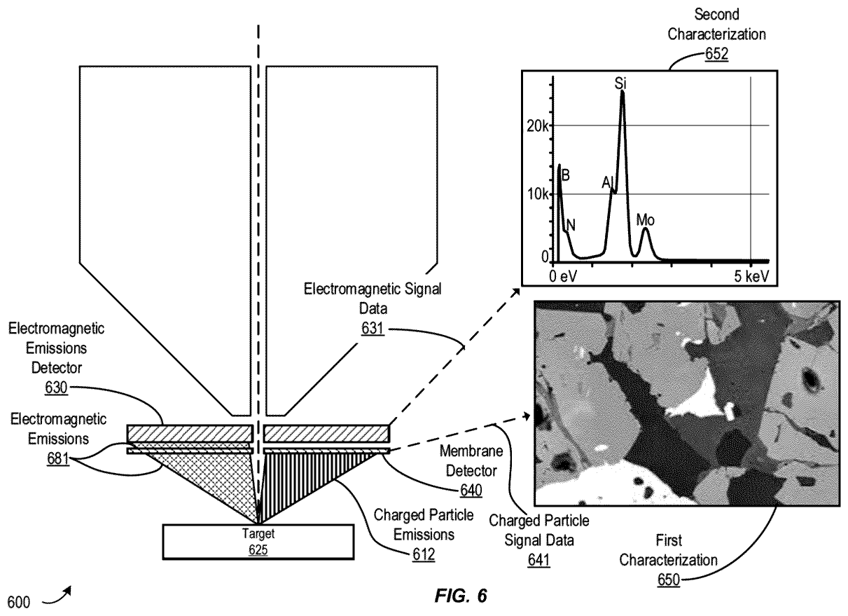

FIG. 6 is a simplified schematic diagram of an example portion of a simultaneous EDS and X-ray charged particle microscope producing target data, in accordance with some embodiments. The BSE and EDS 600 may include some or all components and/or configurations with respect to FIGS. 1, 2, 4, 5, 7, 8, 11, 12, and 14 and may function according to some or all operations and/or steps with respect to FIG. 13. The BSE and EDS detector device 600 includes an electromagnetic emissions detector 630 and a membrane detector 640. While the electromagnetic emissions detector 630 and membrane detector 640 are shown substantially in the configuration shown with respect to FIG. 4, the configuration with respect to FIG. 5 may be suitably implemented.

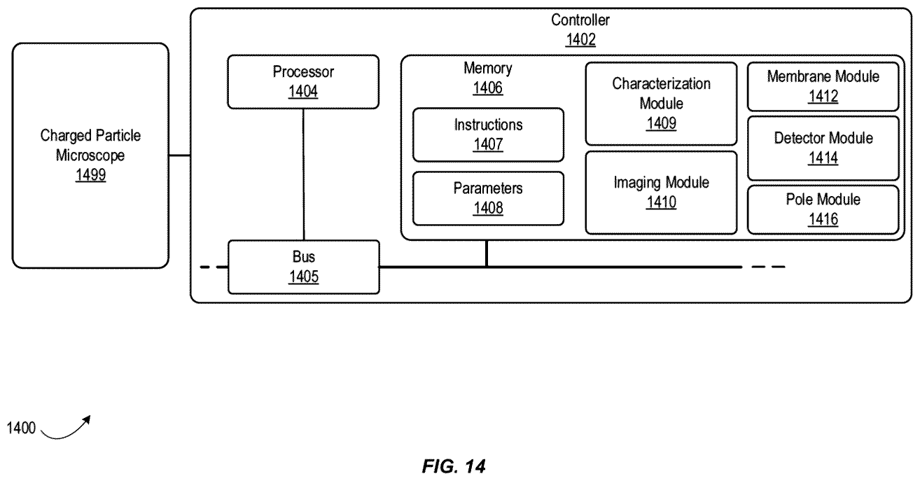

As previously mentioned, when a target 625 interacts with a charged particle beam (not labeled), charged particle emissions 612 (e.g., BSE, scattered electrons, etc.) and/or electromagnetic emissions 681 (e.g., X-rays, infrared, etc.) for the membrane detector 640 and the electromagnetic emissions detector 630 to detect, respectively. For example, when charged particle emissions 612 are emitted by the target 625, the membrane detector 640 may capture some or all of the charged particle emissions 612 and relay, or otherwise output, charged particle signal data to a controller for signal processing (e.g., controller 1402 with respect to FIG. 14). The charged particle signal data may be generated by one or more of, without limitation, a segmented back side, a segmented front side, a front side metallic contact, a back side metallic contact, a doped front segment, a doped back segment, a carbonized front segment, a carbonized back segment, or combinations thereof. The charged particle signal data 641 may be processed by the controller to generate of one or more of, without limitation, a target surface profile, a target internal structure profile, a target composition profile, a target shape profile, a target dimension profile, or combinations thereof. In some examples, the controller may process the charged particle signal data 641 generate one or more first characterizations 650 such as, but not limited to, images, videos, histograms, or combinations thereof for output (e.g., output to a GUI).

Regarding the electromagnetic emissions detector 630, the electromagnetic emissions 681 may be captured by a surface of the electromagnetic emissions detector 630 and converted into electromagnetic signal data 631 which may be relayed, or otherwise output, to the controller (not depicted) for signal processing. For example, the electromagnetic emissions detector 630 may receive X-rays, which substantially passed through the membrane detector 640 uninhibited, which carry characterization information about the target 625. The controller may process the electromagnetic signal data 631 in order to generate a second characterization 652 including, without limitation, a target chemical composition (e.g., a spectral peak depicting sodium (Na), Copper (Cu), etc.) or target concentration (e.g., an intensity of the spectral peak depicting %14 Na, 25% Cu, where the percentage is a weight percentage, etc.). In some examples, the controller may process the electromagnetic signal data 631 and generate one or more second characterizations 652 such as, but not limited to, images, videos, histograms, spectral graphs, or combinations thereof for output (e.g., output to a GUI).

FIG. 7 is a simplified schematic diagram of an example process 700 for attaching a membrane detector 740 to an electromagnetic emissions detector 730, in accordance with some embodiments. The process 700 may include some or all components and/or configurations with respect to FIGS. 1, 2, 4-6, 8, 11, 12, and 14 and may include functions according to some or all operations and/or steps with respect to FIG. 13. An electromagnetic emissions detector 730 may be attached to a retractable arm or support and include an aperture 779 between a top surface and a bottom surface which receives a charged particle beam 706 therethrough. The electromagnetic emissions detector 730 may be a part of a charged particle microscope (e.g., charged particle microscope 100 with respect to FIG. 1) or may be, without limitation, a modular detector which may be retrofit into an existing microscope system. The electromagnetic emissions detector 730 may include a number of electromagnetic emission apertures 780 which may at least partially surround the aperture 779. The number of electromagnetic emission apertures 780 may be configured to receive electromagnetic emissions from the target 725 and, in some examples, may include any suitable number of apertures (e.g., two apertures, four apertures, etc.).

A membrane detector 740 may be coupled to a surface (e.g., bottom surface facing the target 725) of the electromagnetic emissions detector 730. In some examples, the membrane detector 740 may be coupled by a coupler including, but not limited to, an adhesive, a mechanical coupler (e.g., screw, nut, bolt, etc.), snap-fit lock, tape, a latch, a protrusion (e.g., pin holder), or combinations thereof. The membrane detector 740 may include one or more bias components 731. For example, the membrane detector 740 may include, without limitation, a wire, a trace, bonding pads, an electrode, or similar for connecting the membrane detector 740 to microscope circuitry (not depicted), the electromagnetic emissions detector 730, a controller (e.g., controller 1402 with respect to FIG. 14), or any suitable component capable of receiving signals (e.g., charged particle signal data 641 with respect to FIG. 6) from the membrane detector 740. In addition, or alternatively, the bias components 731 may be configured to provide an electric potential to the membrane detector 740 (e.g., by way of a segmented top side 843 and/or a segmented bottom side 842 with respect to FIG. 8).

In some examples, the membrane detector 740 may be coupled to the electromagnetic emissions detector 730 in such a way so as to protect the electromagnetic emissions detector 730 from being damaged by charged particles. In a non-limiting example, the membrane detector 740 may have sufficient length (e.g., one millimeters (mm) to fifty mm), width (e.g., one millimeters (mm) to fifty mm), and thickness (e.g., fifty nm to ten μm) so as to substantially mitigate, or otherwise limit, charged particles from reaching the electromagnetic emission apertures 780 (shown with dashed lines on the right as the membrane detector 740 substantially covers the electromagnetic emission apertures 780 when installed) which would damage the electromagnetic emissions detector 730 (e.g., a silicon drift detector).

FIG. 8 is a simplified schematic diagram of an example dual detector configuration 800, in accordance with some embodiments. The dual detector configuration 800 may include some or all components and/or configurations with respect to FIGS. 1, 2, 4, 5, 7, 8, 11, 12, and 14 and may function according to some or all operations and/or steps with respect to FIG. 13. The dual detector configuration 800 includes a pole member 804 which receives a charged particle beam (not depicted) through a passage 879 therethrough. In addition, an electromagnetic emissions detector 830 receives the charged particle beam from the passage 879 through a first aperture 878 suitably sized to facilitate the charged particle beam. After passing through the first aperture 878 the charged particle beam passes through a second aperture 876 of a membrane detector. In some examples, the passage 879, first aperture 878, and/or the second aperture 876 may be substantially concentrically aligned about a center of one or more of the passage 879, first aperture 878, and/or the second aperture 876. The first aperture 878 and/or the second aperture 876 may have similar diameters or may include suitably differing diameters depending on distance to the target (e.g., target 125 with respect to FIG. 4) and/or the operations of the microscope.

The membrane detector 840 may include one or more segmented areas. For example, the membrane detector 840 may include a segmented top side 843 and/or a segmented bottom side 842 with a membrane 845 (e.g., diamond layer) therebetween. The segmentation may be, but not limited to, metallic contacts separating one or more portions and/or areas of the membrane for angular charged particle detection (e.g., electrons), one or more doped areas creating segmented areas in a pattern, carbonization of one or more areas of the membrane 845, or combinations thereof. The membrane 845 may include a membrane thickness 841. The membrane thickness 841 may be in a range from fifty nm to fifty μm. In some examples, the membrane 845, the segmented top side 843, the segmented bottom side 842 may be configured in a unitary configuration without separate layers as depicted. In addition, or alternatively, an electric potential (e.g., from 0.1 volts (V) to five kV) may be applied between the segmented top side 843 and the segmented bottom side 842 to alter a quantum detection efficiency (e.g., how much signal the detector provides per electron). This bias may be between around fifty V (or higher) per μm of thickness of the membrane detector 840. For example, for a fifty μm thick membrane detector 840 with one hundred V applied per μm, a bias of five kV would be applied to achieve desired detection efficiencies. In another non-limiting example, a fifty μm thick membrane detector 840 may be biased, relative to the target, between one keV and one hundred keV, with a segmented top side 843 and segmented bottom side 842 biased between 0.1 V to five kV, respectively. It should be readily recognized that suitably lower biases than one keV and suitably higher biases than one hundred keV are within the scope of this disclosure. In some examples, a detection threshold may be increased or decreased by applying a bias voltage (e.g., ten kV or lower) between the membrane detector 840 as a whole and the target thus accelerating (or decelerating) the electrons thus changing respective energies which results in whether or not the electrons may be detected.

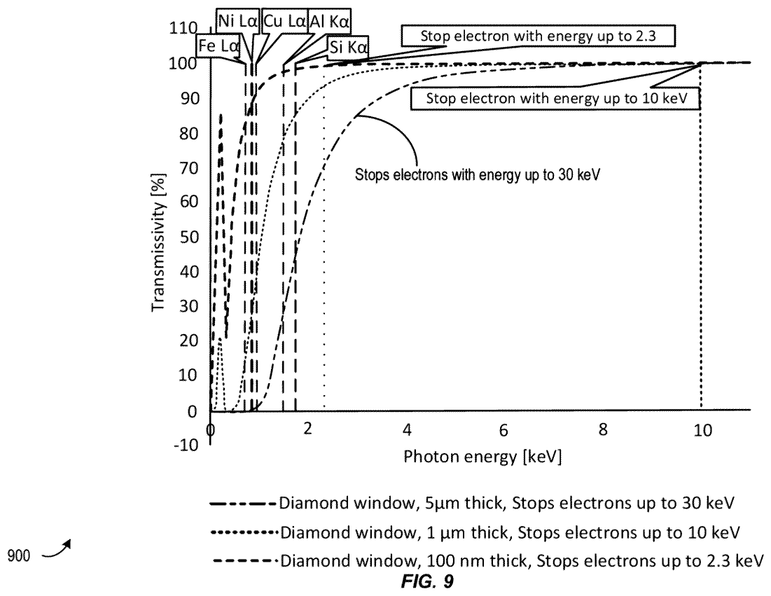

FIG. 9 is a simplified example graph 900 of X-ray transmissivity for a diamond membrane, in accordance with some embodiments. The graph 900 shows three example plots of varying membrane detector thickness with photon transmissivity percentages as a function of photon energy. For example, for a membrane detector (e.g., membrane detector 840 with respect to FIG. 8) that is made of diamond which is one hundred nm thick is able to stop electrons up to 2.3 keV and permits a large amount of X-rays to pass through at low photon energies which is optimal for achieving a strong signal for low photon energy iron (Fe), nickel (Ni), and Cu Lyman-alpha (Ly-α) lines. While only Fe, Ni, and Cu Ly-α have been depicted for clarity and discussion, it should not be considered limiting, and any suitable Ly-α lines associated within appropriate energy ranges may be detected. In the next non-limiting example, for a thickness of diamond of one μm, the diamond may stop electrons up to around ten keV and provide a good signal for aluminum (Al) and silicon (Si) k-alpha (k-α) lines. As the thickness (e.g., membrane thickness 841) of the diamond increases, an amount of electrons that may potentially pass through the diamond decreases. Similarly, but to a lesser extent compared to charged particles, the thicker the diamond, the more the X-rays will be attenuated.

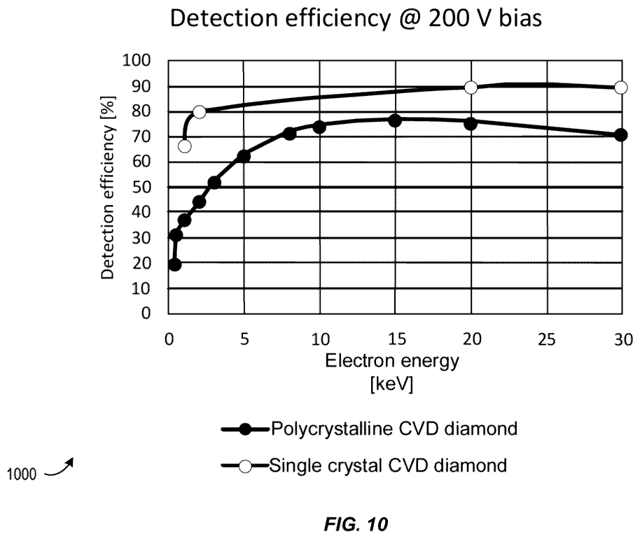

FIG. 10 is a simplified example graph 1000 of detection efficiency of various diamond membranes, in accordance with some embodiments. The graph 1000 shows two example plots of different membrane detector materials plotted by electron energy in keV as a function of detection efficiency percentage. For example, a membrane detector made of polycrystalline chemical vapor deposition (CVD) diamond held at a two-hundred-volt electrical potential bias, the detection efficiency of the polycrystalline CVD diamond membrane detector provides an optimal detection threshold for electrons with energy in a range between five keV and thirty keV. In another non-limiting example, a membrane detector made of single crystal CVD diamond provides over an eighty percent detection efficiency for electrons having energy in a range around two keV to thirty keV. While a range between two keV and thirty keV is discussed as an example detection efficiency range, it should not be considered limiting and suitable energies two keV and lower, and thirty keV and higher, and energies therebetween, are anticipated within the scope of this disclosure.

FIG. 11 is a simplified side view of a membrane detector carousel 1190, in accordance with some embodiments. The membrane detector carousel 1190 may include or be coupled to some or all components and/or configurations with respect to FIGS. 1, 2, 4, 5, 7, 8, 12, and 14 and may function according to some or all operations and/or steps with respect to FIG. 13. The detector carousel 1190 is movable relative to a pole member 1004 and/or one or more electromagnetic emissions detectors 1030 (only one depicted for clarity). The detector carousel 1190 may facilitate a modifiable transmissivity by including a number of membrane detectors 1140a-1140n, where n is an integer number of membrane detectors in line with the electromagnetic emissions and charged particle emissions received from a target (not depicted). For example, five membrane detectors are depicted in line with the electromagnetic emissions and charged particle emissions while two membrane detectors (e.g., membrane detectors 1140a and 1140b) are depicted in a retracted or otherwise removed state away from the electromagnetic emissions and charged particle emissions. In this non-limiting example, membrane detectors 1140a and 1140b may be protected by a shield when retracted to prevent ions and milling material from collecting on the unused membrane detectors 1140a-n when not directly detecting charged particle emissions.

Each of the membrane detectors 1140a-n may be rotated into position below (e.g., relative to a transmission axis of a charged particle beam) an electromagnetic emissions detector 1030 and a pole member 1004. The transmissivity of the electromagnetic emissions and charged particle emissions, in turn, is proportional to the number of membrane detectors 1040a-n that are in position. For example, in an experiment interrogating a semiconductor of interest, it may be unknown how many charged particle emissions and electromagnetic emissions will be generated. A user (or automatically by the system by way of controller 1402 with respect to FIG. 14) may add in any suitable number of membrane detectors 1140 in line to attenuate or otherwise limit one or both of the electromagnetic emissions and charged particle emissions. The membrane detectors 1140 each include an aperture (not labeled) which receives the charged particle beam therethrough. In some embodiments, membrane detectors 1140 may be inserted based on a decision (e.g., user defined, machine initiated, etc.) of which energy of electrons are desired (e.g., a single μm membrane for ten keV electrons, two one μm membranes for fifteen keV electrons, etc.) and to ensure that no electrons reach the electromagnetic emissions detector 1030.

In some examples, the one or more electromagnetic emissions detector 1030 may be attached to one or more off the membrane detectors 1140a-n and suitably rotate with one or more of the membrane detectors 1140a-n. In addition, or alternatively, one or more of the electromagnetic emissions detectors 1030 and/or the membrane detectors 1140a-n may be placed off-axis, on-axis, or a suitable combination thereof (e.g., configurations with respect to FIG. 4 and FIG. 5). In some embodiments, the carousel 1190 may be substituted and/or supplemented with one or more translational arms which linearly translate one or more of the electromagnetic emissions detectors 1030 and/or the membrane detectors 1140a-n in line with the charged particle beam. Each of the membrane detectors 1140a-n may have different configurations or the same configuration. For example, some of the membrane detectors 1140a-n may include a thickness of one μm while others may include a thickness of five μm. The membrane detectors 1140a-n may include suitably different segmented surfaces (as discussed previously). In some examples, the membrane detectors 1140a-n may be held at different electric potentials. For example, membrane detector 1140a may be held at two hundred volts while membrane detector 1140b may be held at two hundred and fifty V.

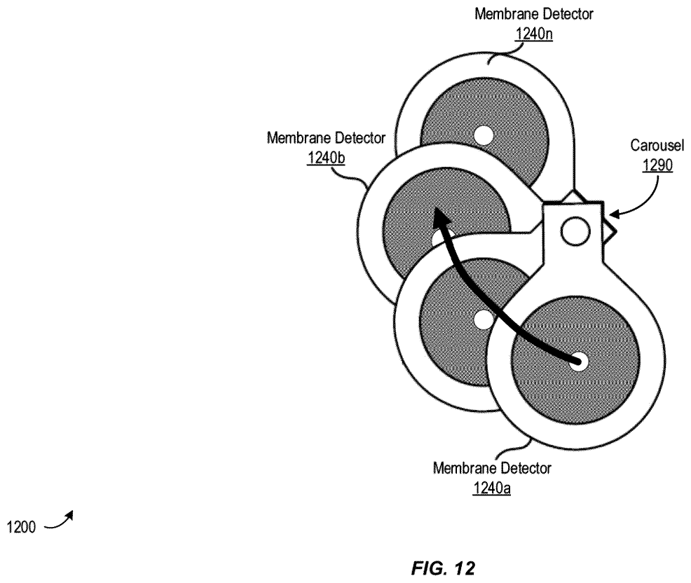

FIG. 12 is a simplified top view of a membrane detector carousel 1200, in accordance with some embodiments. The membrane detector carousel 1200 may include or be coupled to some or all components and/or configurations with respect to FIGS. 1, 2, 4, 5, 7, 8, 12, and 14 and may function according to some or all operations and/or steps with respect to FIG. 13. An axis of rotation exists about a support of a carousel 1290 where rotation of one more membrane detectors 1240a-n may rotate about an axis. In some embodiments, the motion is linear, rather than rotational, with membrane detectors 1240a-n elements being retracted behind a shield (not depicted) via linear translation. The shield can be moveable relative to the membrane detectors 1240a-n and/or an electromagnetic emissions detector (e.g., electromagnetic emissions detector 1030). For example, the shield can be moved into a position to protect the membrane detectors 1240a-n and the electromagnetic emissions detector, as when a process is undertaken that generates a damaging environment (e.g., ion-beam milling of a sample that generates significant ion and electron flux).

FIG. 13 is a simplified block flow diagram, in accordance with some embodiments. In some embodiments, the flow diagram 1300 may include more or fewer steps than the number depicted in FIG. 13. It should be appreciated that the steps of the flow diagram 1300 may be performed in any suitable order. The flow diagram 1300 may be performed by some or all components of systems, devices, and/or include the processes, methods, or techniques as those described in relation to FIGS. 1-12 and 14.

The flow diagram 1300 may begin at step 1302 where a charged particle beam may be directed towards a target. The charged particle beam (e.g., electrons) may be generated by a charged particle source (e.g., charged particle source 103 with respect to FIG. 1) and transmitted along a beam column (e.g., beam column 105) towards a target (e.g., target 125 with respect to FIG. 2).

At step 1304, the target may generate charged particle emissions (e.g., charged particle emissions 412 with respect to FIG. 4) and electromagnetic emissions (e.g., electromagnetic emissions 481 with respect to FIG. 4). The charged particle emissions may include backscattered electrons from the target. In some examples, the electromagnetic emissions may include X-rays from the target.

At step 1306, a membrane detector (e.g., single crystalline CVD diamond or polycrystalline CVD diamond) may receive the charged particle emissions and electromagnetic emissions from the target. In some examples, the membrane detector may at least partially absorb a portion of the charged particle emissions and may be at least partially transparent to the electromagnetic emissions. For example, the membrane detector absorbs electrons with energy lower than a threshold (e.g., for a suitable membrane detector thickness, up to five keV).

At step 1308, the membrane detector may output a charged particle signal (e.g., charged particle signal data 641 with respect to FIG. 6) based at least in part on the membrane detector interacting with the charged particle emissions. In some examples, the membrane detector may include metallic contacts (e.g., a segmented electrode) on one or more sides in order to effectively relay the charged particle signal to a suitable component (e.g., controller 1402 with respect to FIG. 14).

At step 1310, an electromagnetic emissions detector (e.g., a silicon drift detector) may output electromagnetic signal data based at least in part on the electromagnetic emissions received after passing through the membrane detector. In some examples, the electromagnetic emissions detector may be in direct contact with the membrane detector (e.g., as depicted with respect to FIG. 7) or may be located a distance away either on-axis (e.g., as depicted with respect to FIG. 4) or obliquely placed off-axis (e.g., as depicted with respect to FIG. 5).

At step 1312, target data may be generated based at least in part on the charged particle signal data, the electromagnetic signal data, or both. The target data may include characterizations (e.g., first characterization 650 and/or second characterization 652 with respect to FIG. 6). In some examples, a topology mapping (e.g., a two-dimensional surface profile) of the target may be generated from the target data by way of the charged particle emissions detected at the membrane detector. An energy dispersive spectroscopy (EDS) spectrum correction may be generated by at least partly applying the topology mapping to the target data. Corrections for EDS image segmentation may be based on electron data. Different materials may have different scattered electron/BSE emissions and thus do not have enough EDS data to do a viable analysis. Combining the EDS data with the BSE data provides a suitable improved alternative compared to when the data is used independently of one another. In addition, materials with high-Z (e.g., atomic number) have higher BSE emissivity for some energies, so for a given energy range a BSE image and EDS data may be combined by using the BSE image to produce material contrast, thus yielding more information about the target.

FIG. 14 is a simplified controller diagram for a charged particle microscope, in accordance with some embodiments. A controller 1402 for performing methods, processes, techniques, and similar for a charged particle microscope 1499 according to certain embodiments. Examples of the charged particle microscope 1499 can include some or all components of microscope systems from FIGS. 1, 2, 4-8, 11, 12. Examples of the methods, processes, techniques, operations, can include some or all methods, processes, techniques, operations of FIG. 13. As shown, the controller 1402 may include a processor 1404 communicatively coupled to memory 1406. The processor 1404 can include one processing device or multiple processing devices. Non-limiting examples of the processor 1404 include a Field-Programmable Gate Array (FPGA), an application specific integrated circuit (ASIC), a microprocessor, or any combination of these. The processor 1404 can execute instructions 1407 stored in the memory 1406 to perform operations, such as the operations of microscopes, processes, scans, and methods of FIG. 13. In some examples, the instructions 1407 can include processor-specific instructions generated by a compiler or an interpreter from code written in any suitable computer-programming language, such as C, C++, C#, Python, or Java.

The memory 1406 can include one memory device or multiple memory devices. The memory 1406 can be non-volatile and may include any type of memory device that retains stored information when powered off. Non-limiting examples of the memory 1406 include electrically erasable and programmable read-only memory (EEPROM), flash memory, or any other type of non-volatile memory. At least some of the memory 1406 can include a non-transitory computer-readable medium from which the processor 1404 can read instructions 1407 via bus 1405. The bus 1405 may be a communication and/or power bus that enables processor 1404 to communicate with memory 1406. The non-transitory computer-readable medium can include electronic, optical, magnetic, or other storage devices capable of providing the processor 1404 with the instructions 1407 or other program code. Non-limiting examples of the non-transitory computer-readable medium include magnetic disk(s), memory chip(s), RAM, an ASIC, or any other medium from which a computer processor can read instructions 1407.

The memory 1406 can further include operation information about parameters 1408 (e.g., calibrations, image capture, electrical bias, power, carousel translations/rotations), characterization module 1409 (e.g., composition software, look-up tables, etc.), imaging module 1410 (e.g., detector imaging, video processing, image processing, signal processing), membrane module 1412 (e.g., calibration, electrical bias, position), detector module 1414 (e.g., calibration, electrical bias, position), pole module 1416 (e.g., electrical bias). The controller 1402 can receive the information about operating parameters from a microscope, such as a TEM, SEM, or similar. At least some of the information about any of the controller 1402 components can be pre-stored and can be associated with a various scanning passes (e.g., acquisitions). The parameters 1408 can include operating parameters associated with an electron microscope system, such as a desired energy/primary energy of an electron beam, an energy spread of an energy loss spectrum, lockup mechanisms, feedback loops, etc. In some examples, some of the parameters 1408 can be compared to the predetermined thresholds (e.g., known arrangements, known sample types, etc.).

The terms and expressions which have been employed are used as terms of description and not of limitation, and there is no intention in the use of such terms and expressions of excluding any equivalents of the features shown and described or portions thereof, but it is recognized that various modifications are possible within the scope of the claims. Thus, it should be understood that although the present disclosure includes specific embodiments and optional features, modification and variation of the concepts herein disclosed may be resorted to by those skilled in the art, and that such modifications and variations are considered to be within the scope of the appended claims.

As used in this application and in the claims, the singular forms “a”, “an”, and “the” include the plural forms unless the context clearly dictates otherwise. Additionally, the term “includes” means “comprises”. Further, the term “coupled” does not exclude the presence of intermediate elements between the coupled items.

The systems, apparatuses, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatuses are not limited to any specific aspect or feature or combinations thereof, nor do the disclosed systems, methods, and apparatuses require that any one or more specific advantages be present or problems be solved. Any theories of operation are to facilitate explanation, but the disclosed systems, methods, and apparatuses are not limited to such theories of operation.

Although the operations of some of the disclosed methods are described in a particular, sequential order for convenient presentation, it should be understood that this manner of description encompasses rearrangement, unless a particular ordering is required by specific language. For example, operations described sequentially may in some cases be rearranged or performed concurrently. Moreover, for the sake of simplicity, the attached figures may not show the various ways in which the disclosed systems, methods, and apparatuses can be used in conjunction with other systems, methods, and apparatuses. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one or ordinary skill in the art.

The term “image” is intended to comprise a two-dimensional grid, wherein the two-dimensional grid can comprise at least one or a plurality of portions. Each portion is characterized by its coordinates and its value (color and/or intensity). Thus, the image may refer to a visual representation of the sample in gray level variations and/or color variations and/or intensity variations. Further, each portion in the image may correspond to a point (e.g. location) on the target or a sublocation on the target, or similar.

Some embodiments of the present disclosure include a system including one or more data processors and/or logic circuits. In some embodiments, the system includes a non-transitory computer readable storage medium containing instructions which, when executed on the one or more data processors and/or logic circuits, cause the one or more data processors and/or logic circuits to perform part or all of one or more methods and/or part or all of one or more processes and workflows disclosed herein. Some embodiments of the present disclosure include a computer-program product tangibly embodied in non-transitory machine-readable storage media, including instructions configured to cause one or more data processors and/or logic circuits to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the claims. Thus, it should be understood that although the present disclosure includes specific embodiments and optional features, modification and variation of the concepts herein disclosed may be resorted to by those skilled in the art, and that such modifications and variations are considered to be within the scope of the appended claims.

Where terms are used without explicit definition, it is understood that the ordinary meaning of the word is intended, unless a term carries a special and/or specific meaning in the field of charged particle microscopy systems or other relevant fields. The terms “about” or “substantially” are used to indicate a deviation from the stated property within which the deviation has little to no influence of the corresponding function, property, or attribute of the structure being described. In an illustrated example, where a dimensional parameter is described as “substantially equal” to another dimensional parameter, the term “substantially” is intended to reflect that the two parameters being compared can be unequal within a tolerable limit, such as a fabrication tolerance or a confidence interval inherent to the operation of the system. Similarly, where a geometric parameter, such as an alignment or angular orientation, is described as “about” normal, “substantially” normal, or “substantially” parallel, the terms “about” or “substantially” are intended to reflect that the alignment or angular orientation can be different from the exact stated condition (e.g., not exactly normal) within a tolerable limit. For numerical values, such as diameters, lengths, widths, or the like, the term “about” can be understood to describe a deviation from the stated value of up to ±10%. For example, a dimension of “about 20 mm” can describe a dimension from fifteen mm to twenty-five mm.

Where terms such as simultaneous or contemporaneously or similar are used, it is understood that the ordinary meaning of the word is intended. In addition, the terms are used to describe events or actions that one skilled in the art would recognize as occurring substantially at a same temporal time.

Where terms such as “off-axis”, “obliquely”, “on-axis”, “coaxially” are used, it is understood that these terms are relative positions and unless otherwise defined herein are used to describe a relative position of one or more components relative to a transmission axis of a charged particle beam, an axis of one or more apertures. When terms such as “top” or “bottom” are used, it is understood that the terms are relative positions with respect to one or more components and are used to readily identify a position and/or orientation of one or more components with respect to other components. In addition, where terms such as “proximal” or “proximate” are used, it is understood that these terms are used to define a spatial position of one or more components and may represent direct physical contact or no physical contact but close spatial positions. Where the term “thin” is used, it is understood that this term represents a thickness of a layer between twenty nanometers and five hundred micrometers unless otherwise defined. The terms used herein are not intended to be limiting and one skilled in the art would recognize suitable equivalents and reference points.

The description provides exemplary embodiments, and is not intended to limit the scope, applicability or configuration of the disclosure. Rather, the ensuing description of the exemplary embodiments will provide those skilled in the art with an enabling description for implementing various embodiments. It is understood that various changes may be made in the function and arrangement of elements without departing from the spirit and scope as set forth in the appended claims. Specific details are given in the description to provide a thorough understanding of the embodiments. However, it will be understood that the embodiments may be practiced without these specific details. For example, specific system components, systems, processes, and other elements of the present disclosure may be shown in schematic diagram form or omitted from illustrations in order not to obscure the embodiments in unnecessary detail. In other instances, well-known circuits, processes, components, structures, and/or techniques may be shown without unnecessary detail.

What is claimed is:

1. A method for imaging in charged particle microscopy comprising:
directing, by a charged particle beam source, a charged particle beam towards a target, wherein interactions of the charged particle beam with the target generate charged particle emissions and electromagnetic emissions;
receiving, by a membrane detector, the charged particle emissions and the electromagnetic emissions, wherein the membrane detector at least partially absorbs a portion of the charged particle emissions and is at least partially transparent to the electromagnetic emissions;
outputting, by the membrane detector, charged particle signal data based at least in part on the portion of the charged particle emissions received by the membrane detector;
outputting, by an electromagnetic emission detector, electromagnetic signal data based at least in part on the electromagnetic emissions that pass through the membrane detector; and
generating target data based at least in part on i) the charged particle signal data, ii) the electromagnetic signal data, or both i) and ii).

2. The method of claim 1, wherein the membrane detector is a diamond membrane detector; and wherein outputting the charged particle signal data further comprises:
absorbing, by the diamond membrane detector, electrons from the charged particle emissions; and
generating image data based at least in part on the electrons, wherein the target data includes the image data.

3. The method of claim 1, wherein the electromagnetic emission detector is an energy dispersive spectroscopy (EDS) detector and the electromagnetic emissions are X-ray emissions; and wherein outputting the electromagnetic signal data further comprises:
receiving, by the EDS detector, the X-ray emissions that pass through the membrane detector; and
generating target characterization data based at least in part on the X-ray emissions, wherein the target data includes the target characterization data.

4. The method of claim 1, further comprising:
detecting, by the membrane detector, electrons having an energy in an energy range between 1 kiloelectron volts (keV) to 100 keV.

5. The method of claim 1, wherein directing the charged particle beam towards the target further comprises:
directing the charged particle beam through a passage of a pole member;
directing the charged particle beam through a first aperture in the electromagnetic emission detector; and
directing the charged particle beam through a second aperture in the membrane detector, wherein the passage, the first aperture, and the second aperture are coaxially aligned along an axis which passes through the passage, the first aperture, and the second aperture.

6. The method of claim 5, wherein generating the target data occurs without moving the pole member, the electromagnetic emission detector, or the membrane detector with respect to one another; and wherein outputting the charged particle signal data and the electromagnetic signal data occurs substantially contemporaneously.

7. The method of claim 1, further comprising:
generating a topology mapping of the target using the charged particle emissions; and
generating an energy dispersive spectroscopy (EDS) spectrum correction by at least partly applying the topology mapping to target data.

8. An apparatus for imaging in charged particle microscopy comprising:
a charged particle source configured to generate a charged particle beam that is configured to interact with a target to generate charged particle emissions and electromagnetic emissions;
a membrane detector configured to receive the charged particle emissions and the electromagnetic emissions, wherein the membrane detector at least partially absorbs a portion the charged particle emissions and is at least partially transparent to the electromagnetic emissions, wherein the membrane detector is further configured to output charged particle signal data based at least in part on the membrane detector interacting with the charged particle emissions;
an electromagnetic emission detector configured to output electromagnetic signal data based at least in part on the electromagnetic emissions that pass through the membrane detector; and
a controller configured to generate target data based at least in part on i) the charged particle signal data, ii) the electromagnetic signal data, or both i) and ii).

9. The apparatus of claim 8, wherein the controller is further configured to generate an image of the target based at least in part on i) the charged particle signal data, ii) the electromagnetic signal data, or both i) and ii).

10. The apparatus of claim 8, wherein the electromagnetic emission detector is a silicon drift detector.

11. The apparatus of claim 8, wherein the membrane detector is configured to be biased with an electric potential relative to the target to change an electron detection threshold.

12. The apparatus of claim 8, wherein the membrane detector is configured with a segmented electrode for angular electron detection.

13. The apparatus of claim 8, wherein the membrane detector has a first configuration, and wherein the apparatus further comprises:
a second membrane detector having a second configuration, wherein the first configuration is different than the second configuration.

14. The apparatus of claim 13, wherein the first configuration includes i) a first thickness of the membrane detector, ii) a first bias of the membrane detector, iii) a first position of the membrane detector, or combinations thereof, and wherein the second configuration includes i) a second thickness of the second membrane detector, ii) a second bias of the second membrane detector, iii) a second position of the second membrane detector, or combinations thereof.

15. A device for imaging in charged particle microscopy comprising:
a membrane detector configured for placement with respect to a charged particle beam that generates charged particle emissions and electromagnetic emissions when interacting with a target, wherein the membrane detector is configured to at least partially absorb the charged particle emissions and be at least partially transparent to the electromagnetic emissions, wherein the membrane detector is further configured to output charged particle signal data based at least in part on the membrane detector interacting with the charged particle emissions; and
an electromagnetic emission detector configured to output electromagnetic signal data based at least in part on the electromagnetic emissions that pass through the membrane detector.

16. The device of claim 15, wherein the membrane detector comprises:
a segmented area; and
a thin diamond membrane detector coupled to the segmented area, wherein the segmented area is configured to apply a bias voltage across the thin diamond membrane detector.

17. The device of claim 15, wherein the membrane detector has a thickness in a range between 100 nanometers (nm) and 100 micrometers (μm).

18. The device of claim 15, wherein the membrane detector includes a first aperture and the electromagnetic emission detector includes a second aperture, wherein the first aperture and the second aperture are substantially aligned and are configured to receive the charged particle beam therethrough.

19. The device of claim 15, wherein the membrane detector is configured to be coupled to a surface of the electromagnetic emission detector.

20. The device of claim 15, wherein the membrane detector comprises an aperture; and wherein, during operation of the charged particle beam:
the membrane detector is positioned such that the charged particle beam passes through the aperture; and
the electromagnetic emission detector is positioned obliquely with respect to the charged particle beam such that the charged particle beam avoids passing through the electromagnetic emission detector.
